(19) United States
(12) Patent Application Publication
(10) Pub. No.: US 2020/0315762 A1
(43) Pub. Date: Oct. 8, 2020

(54) MESH PET RECOVERY CONE

(71) Applicant: Jaisson A. Correa, Homestead, FL (US)

(72) Inventor: Jaisson A. Correa, Homestead, FL (US)

(21) Appl. No.: 16/375,860

(22) Filed: Apr. 5, 2019

(51) Int. Cl. A61D 9/00; A01K 13/00

(52) U.S. Cl. CPC A61D 9/00; A01K 13/006

(57) ABSTRACT

A protective cone effective as a veterinary restraint when fitted on an animal. The protective cone may have a substantially transparent body with inner and outer arcuate sides extending between end sides. An adjustable closure may releasably secure the end sides into a closed configuration of a truncated cone about an animal's neck and head. The protective cone may have perforations to pass air. The protective cone may have padding on the inner and outer arcuate sides. A substantially circular detachable mesh cover may cover the top opening of the protective cone. A compressible collar may be attached to the bottom opening of the protective cone.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of veterinary devices and practices. More specifically, the invention is a pet or animal recovery cone to keep dogs and other animals from accessing and chewing on sensitive areas while they recover.

### 2. Description of the Related Art

Various The following includes information that may be useful in understanding the invention(s). It is not an admission that any of the information provided herein is prior art, or material to the presently described or claimed invention, or that any publication or document that is specifically or implicitly referenced is prior art.

The invention relates to a kind of veterinary restraint for animals that is commonly called an “Elizabethan collar” or an “E-collar.” Such a veterinary restraint also may be referred to as a “Buster collar,” “Medical collar,” “recovery cone,” “protective collar,” or “pet cone.” Sometimes such a veterinary restraint is humorously called a “pet lamp-shade,” “pet radar dish,” “dog-saver,” or “cone of shame”. An “E-Collar” is a protective medical device worn by an animal, usually a domesticated cat or dog.

When wounded or recovering from surgery or when a surface infection or infestation (such as by fleas) is present on its body, an animal may instinctively lick or bite at the site of the injury, incision, infection, or infestation. Repeated licking or biting may result in slower healing and increased risk of infection and can result in the ingestion by the animal of medication that has been applied to the problem site topically. For animals that have undergone a surgical procedure, licking or biting further risks damaging sutures or staples placed to keep the surgical wound closed while the healing process proceeds. Also, if an injury, surgical incision, infection, or infestation is located on an animal's neck or head, the animal may attempt to scratch the problem site with its nails or claws, to similarly damaging effect.

Shaped like a truncated cone, the purpose of an E-collar is to prevent the animal from biting or licking its body or scratching at its head or neck while wounds or injuries heal or an infection or infestation is treated. The E-collar physically prevents the animal from reaching the problem site with its mouth and tongue (if the site is on the animal's body). The E-collar also prevents the animal from scratching the problem site with its nails or claws (if the site is on the animal's neck or head).

An E-collar usually is formed from materials such as sheets of plastic, cardboard, or fabric. E-collars are provided in a range of sizes in order to accommodate animals of different sizes. Fitting an E-collar on an animal is relatively simple. The E-collar, as noted, is shaped as a truncated cone. To fit an E-collar on an animal, the E-collar is opened, if not already open, or widened if necessary generally by pulling apart the E-collar along a pre-cut or pre-configured opening. Fitting involves placing the bottom opening (also referred to as the inner edge) of the E-collar around the animal's neck, and then securing the ends of the E-collar, thus forming a truncated cone around the head of the animal. As a truncated cone, the E-collar increases in diameter from the placement of its bottom opening around the animal's neck through the top opening (also referred to as the outer edge) of the E-collar.

One problem with conventional E-collars is that even if applied and worn correctly, animals with long snouts may still be able to access wounds or other places on their bodies that need to be avoided. A long snout may be longer than the height of an E-collar enabling the animal to reach past the E-collar. Also, an animal may be able to contort his or her body to gain access to areas to be protected even while wearing a conventional E-collar. Further, an animal may be able to dislodge the E-collar or to cause the E-collar to change its truncated cone shape by contorting it in whole or in part to gain access to an area that should be avoided.

Another problem is that an E-collar does not generally hold up well in use on an animal. Most animals dislike wearing E-collars and may work at shedding themselves of their E-collars by using their legs to tear at the E-collars, by shaking their heads to unseat the E-collars, and otherwise. Unaccustomed to wearing an E-collar, an animal may run the E-collar accidentally or on purpose into objects thereby battering the E-collar until its form is distorted and its edges and other areas are ragged.

Yet another problem is the risk of injury to the animal wearing an E-collar. If an animal wearing an E-collar runs the top of it into an object (such as furniture or other solid surface), the force of hitting the object may force the E-collar further down the neck of the animal. This forcing of the E-collar down the neck of the animal may result in a choking hazard and may cause injury to the neck. Further, an E-collar that is forced too far down an animal's neck may defeat the purpose of the animal wearing the E-collar. An E-collar that is forced too far down an animal's neck may allow the animal to reach past the top opening of the E-collar to lick or worry parts of the animal's body that should remain untouched.

An additional problem of an E-collar may arise when an animal wearing an E-collar accompanies a person in a walk or other action. Unaccustomed to the E-collar, the animal wearing it may run the E-collar into the back of the legs of the person or other body part. Being run into by an E-collar of an animal can cause the person pain and even injury especially if the E-collar has sharp or battered edges or is made of a relatively hard material such as tough plastic. Therefore, there is a need for a recovery cone that may be used with an animal and may succeed in its purpose of protecting the animal but may overcome one or more of the problems mentioned above.

### BRIEF SUMMARY OF THE INVENTION

In view of the foregoing problems and disadvantages inherent in the known art, the invention provides a novel recovery cone for animals. The general purpose of the invention, which will be described subsequently in greater detail is to provide a recovery cone that may overcome one or more of the problems discussed in the background. Thus, a purpose of the invention may be to prevent animals wearing recovery cones from reaching wounds or other places on their bodies that may need to be avoided, or to make it more difficult for an animal to dislodge or distort the shape of a recovery cone. Another purpose may be to provide a recovery cone that holds up in use generally better than prior art versions. An additional purpose may be to reduce the risk of injury or choking to an animal in wearing a recovery cone. Further, a purpose of the recovery cone of the invention may be to lessen the pain, injury, or inconvenience to a person walking or otherwise interacting with an animal wearing a recovery cone.

Stated generally, the invention is a recovery cone effective as a veterinary restraint when fitted on an animal. Embodiments of the recovery cone according to the invention may be longer in length (rather than diameter) compared to prior art E-collars. The longer length may be an advantage because it may prevent an animal with a long snout and wearing such a recovery cone from reaching wounds or other places that may need to be avoided. Also, an embodiment having a longer length may make it more difficult for an animal to dislodge or distort the shape of the recovery cone.

Embodiments of the recovery cone according to the invention may include another feature that may make it more difficult for the animal to reach past the length of the recovery cone or to dislodge or distort the recovery cone. That feature may be a mesh cover that may be placed over the top of the recovery cone. The mesh cover may prevent the animal from pushing its snout past the length of the recovery cone. Specifically, the mesh of the mesh cover may be of a tight enough weave or have a construction of small openings to prevent the animal's tongue from extending through the mesh cover. Yet the mesh of the mesh cover may be flexible or stretchy to allow for fitting over the top of the recovery cone. With such a mesh cover, the animal may be denied access to a wound or other area that should be left alone, which protects that area. Being denied access by the mesh cover may also discourage the animal from further attempts providing additional protection. The mesh may have small enough holes to prevent the animal from accessing the wound, yet large enough holes or openings to provide good breathability.

A mesh cover over a recovery cone presents additional advantages. When used with the recovery cone, the mesh cover may provide more structural rigidity to the top opening of the recovery cone and to the recovery cone overall. Also, when used, the mesh cover may minimize contortion and distortion of the top opening of the recovery cone as well as the recovery cone overall. The mesh cover may keep the top opening of the recovery cone in the shape of a circle much better than when a mesh cover is not used. Further, the mesh cover may protect the outer top diameter of the recovery cone from wear and tear. The mesh cover may be easily attached to a recovery cone. For example, a Velcro® brand fastener or other hook and loop fastener may be used to attach the mesh cover to the recovery cone. Another example is that the hook side of hook and loop fastener may be disposed on the outside of the top opening of the recovery cone. The mesh of the mesh cover may be made to stick to the hook side disposed on the outside of the top of the opening of the recovery cone. As another example, elastic may be threaded through the outer diameter of the generally circular mesh cover so the mesh cover may be simply applied over the top of the recovery cone by stretching the elastic, placing the mesh cover over the top opening of the recovery cone, and adjusting the elastic for a relatively snug fit around the recovery cone. Alternatively, the mesh cover may be attached to the recovery cone in other manners.

Another advantage of some embodiments of the recovery cone is that they may include a substantially transparent or see-through main body so the animal may be made more comfortable by being able to see through the recovery cone. Another comfort feature of some embodiments of the invention may be that the body of a recovery cone may be made of mesh or have holes or perforations to allow for air flow through the recovery cone. The mesh, holes, or perforations may allow an animal to breathe more easily. Yet another comfort feature of some embodiments of the recovery cone according to the invention is that an adjustable fit may be provided to a recovery cone to accommodate animals of various sizes. An adjustable closure or fastener in some embodiments may allow for this adjustable fit.

An additional advantage of some embodiments of the recovery cone according to the invention is that padding may be provided on one or more parts of an exemplary recovery cone. For example, an embodiment may include padding around the inner edge of a recovery cone that may cushion the neck of the animal and/or protect the recovery cone. The same or another embodiment may include padding or protective material around the outer edge of a recovery cone. Padding on the outer edge may protect the recovery cone as well as protect a person walking or otherwise interacting with an animal wearing such a recovery cone.

More specifically stated, the invention may include a first exemplary embodiment that also may be referred to as a protective cone. The first exemplary embodiment may include a main body, which may be transparent or otherwise be see-through such as being a mesh body. In this first embodiment, the main body is shaped when open as having an inner arcuate side, an outer arcuate side, a first end side, and a second end side. The inner arcuate side and the outer arcuate side may extend between the first end side and the second end side with the outer arcuate side having a substantially greater radius than the inner arcuate side. The main body of this first embodiment of a protective cone includes at least a fastener to releasably secure the first end side and the second end side into a closed configuration of the main body shaped as a truncated cone. In the closed configuration, the inner opening is smaller in diameter than an outer opening. A mesh cover, that may be detachable, is provided to cover the outer opening of the closed configuration of the main body. Further, the mesh cover may be substantially circular having an outer circumference configured to hold the mesh cover over the outer opening and around the closed configuration of the main body.

The first embodiment of a protective cone may include at least an attachment attached to the inner arcuate side of the main body for attaching the closed configuration of the main body to a collar of the animal. For example, a dog may wear a collar provided by its owner with the collar including identifying information, a place to clip a leash, etc. Advantageously, the protective cone of the first embodiment may have one or more attachments to attach the protective cone to the dog's collar.

The protective cone of the first embodiment may be adjusted to fit animals of different sizes. For example, the protective cone may include a fastener that is adjustable. The adjustable fastener may releasably secure the first end side and the second end side into a smaller closed configuration having a smaller inner opening and a smaller outer opening to accommodate an animal having a smaller neck and head size. One or more snap fasteners may be used with or as the fastener of the first embodiment.

An advantage of the protective cone according to the first embodiment is that it may have one or more perforations in the main body. The one or more perforations may pass air from inside the closed configuration to outside of the closed configuration, and vice versa. The perforations in an embodiment of the protective cone may be disposed in one or more groups of perforations. The perforations may be circular, may be holes, or may be openings.

Also, the protective cone according to the first embodiment may include one or more elements of padding. For example, an embodiment may include inner padding on one or more parts of the inner arcuate side of the main body. Such inner padding may protect the animal's neck when wearing the protective cone and/or protect against wear and tear of the protective cone. The same embodiment or another may include outer padding on one or more parts of the outer arcuate side of the main body. The outer padding may protect the protective cone from wear and tear, and/or may protect a person when interacting with an animal wearing the protective cone with outer padding.

Another feature of a first exemplary protective cone according to the invention is that of a compressible collar attached to the inner edge or inner arcuate side of the main body of the protective cone. If an animal wearing the exemplary protective cone bumps it into a piece of furniture or another solid object, the exemplary protective cone may be pushed down the animal's neck. The compressible collar attached to this embodiment may compress to minimize injury, choking, or discomfort to the neck or other parts of the animal. The compressible collar may be releasably detachable from the remainder of the protective cone.

Advantageously, the invention may provide a second embodiment in a protective collar for positioning around the neck and head of an animal to prevent the animal at least from licking or worrying an area on the body of the animal. This protective collar may include an inverted truncated cone. The protective collar may be made of mesh fabric with two or more supporting ribs. The protective collar may include an opening with a first diameter that fits around the neck of the animal with the wall of the inverted truncated cone growing in diameter from the first diameter to a second diameter that encircles the head of the animal. In this second embodiment, the wall of the inverted truncated cone may be split at least in one location to allow the inverted truncated cone to be fitted around the head and the neck of the animal. The second embodiment provides a fastener or a closure for closing the split wall of the inverted truncated cone in a generally close fit around the head and neck of the animal. The second embodiment also provides a mesh for covering the top of the inverted truncated cone of the collar. The mesh may be detachable from the inverted truncated cone. The second embodiment also may include a compressible neck collar such as explained above with respect to the first embodiment.

Advantageously, the invention provides a third embodiment with variations. This third embodiment includes a protective cone that may be effective as a veterinary restraint when fitted on an animal. The protective cone may include a substantially transparent main body having four sides including an inner arcuate side, an outer arcuate side, a first end side, and a second end side. The inner arcuate side and the outer arcuate side may be generally parallel to each other and extend between the first end side and the second end side. The outer arcuate side may have a substantially greater radius than the inner arcuate side. In this third embodiment, the main body may have at least a fastener to releasably secure the first end side and the second end side into a closed configuration of the main body. The main body may include an inner opening and an outer opening. The inner opening may be substantially smaller than the outer opening. The inner opening may be configured to encompass the neck of the animal but not the head. The outer opening may be configured to encompass at least the head of the animal and to extend beyond the head of the animal.

The third embodiment may be adjustable in size by having a fastener or a closure that includes at least a second fastener to releasably secure the first end side and the second end side into a smaller closed configuration of the main body having a smaller inner opening and a smaller outer opening to accommodate a different animal having a smaller neck and head size.

The main body of the third embodiment may have perforations to pass air from inside the closed configuration to outside of the closed configuration. The main body also may have an inner padding on the inner arcuate side and an outer padding on the outer arcuate side. The third embodiment may provide at least an attachment attached to the inner arcuate side of the main body for attaching the cone to a collar of the animal. Further, the third embodiment may include a substantially circular detachable mesh cover having an outer circumference configured with elastic to hold the mesh cover over the outer opening and around the closed configuration of the main body.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the invention will become better understood with reference to the following drawings and detailed description.

### BRIEF DESCRIPTION OF THE DRAWINGS

The figures which accompany the written portion of this specification illustrate embodiments for the invention, a mesh pet recovery cone, constructed and operative according to the teachings of the invention.

FIG. 1 shows a perspective view illustrating a mesh pet recovery cone worn by a dog according to an embodiment of the invention.

FIG. 2 is a top view illustrating a mesh pet recovery cone according to an embodiment of the invention of FIG. 1.

FIG. 3 is a top view illustrating a mesh pet recovery cone according to an embodiment of the invention of FIG. 1.

FIG. 4 is a perspective view illustrating according to an embodiment of the invention of FIG. 1.

FIG. 5 is a side perspective view illustrating a mesh pet recovery cone worn by a dog according to an embodiment of the invention.

FIG. 6 is a front perspective view illustrating a mesh pet recovery cone according to an embodiment of the invention of FIG. 5.

FIG. 7 is a back perspective view illustrating a mesh pet recovery cone according to an embodiment of the invention of FIG. 5.

The various embodiments of the present invention will hereinafter be described in conjunction with the appended drawings, wherein like designations denote like elements.

### DETAILED DESCRIPTION

The invention is described herein with reference to exemplary embodiments, alternative embodiments, and also with reference to the attached drawings. The invention, however, may be embodied in many different forms and carried out in a variety of ways, and should not be construed as limited to the embodiments set forth herein. The exemplary embodiments that are described and shown herein are only examples of the ways to implement the invention. Others will occur to those skilled in the art.

In terms of nomenclature herein, the singular includes the plural, the masculine includes the feminine and/or neutral, a person includes a corporation, and/or a partnership (and/or the like), and an embodiment, in whole or in part, may be an apparatus, a device, a kit, a method, and/or a system, unless otherwise noted. Generally, the terms “and” and “or” may be interchangeable unless otherwise noted or understood from context. Moreover, like numerals indicate like elements throughout the figures.

As discussed above, embodiments of the invention relate to a recovery cone that may be used as a veterinary restraint when fitted on an animal, although other uses may be made of the recovery cone. It may be referred to herein as a “cone,” “protective cone,” “protective collar,” or “medical collar for pets.”

Generally speaking, the recovery cone of the invention is of a truncated cone shape when worn by an animal around its neck and head and may include a mesh cover over the top opening. According to the invention, the recovery cone may be transparent or substantially see-through so the animal may have a view of 360 degrees. The recovery cone may have openings, hole, or perforations in its main body to allow air to pass through the main body. The recovery cone may be adjustable to fit animals of different sizes. Padding may be applied to parts of the recovery cone such as the bottom opening and/or the top opening or entirely around the perimeter. An embodiment may include a compressible collar attached to the bottom opening of the recovery cone. Details of elements and embodiments of the invention are provided with reference to the figures.

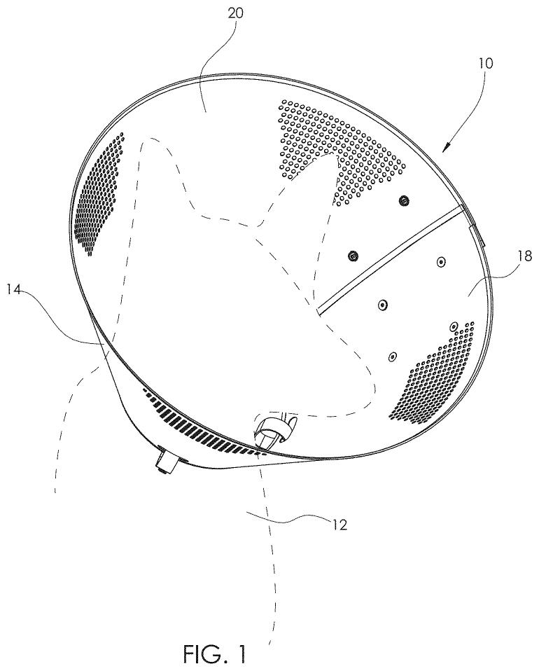

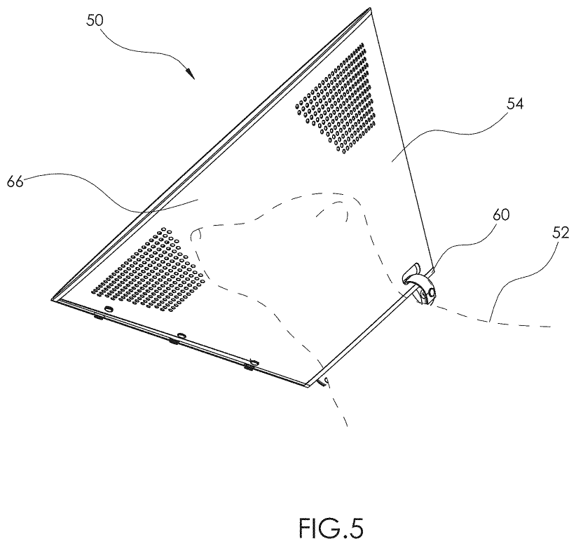

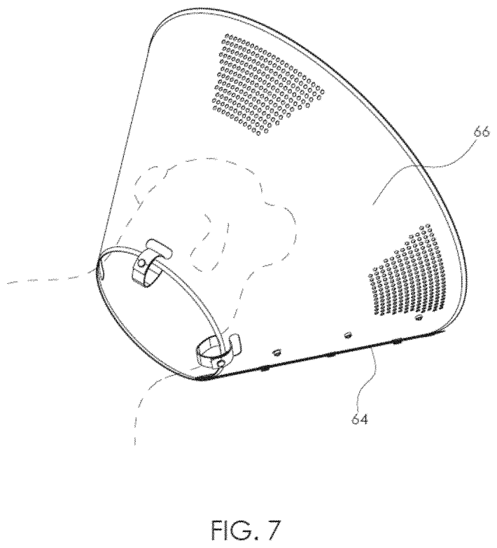

FIGS. 1-4 illustrate an exemplary recovery cone 10 including a mesh cover 20. FIGS. 5-7 illustrate an exemplary recovery cone 50 including a compressible collar.

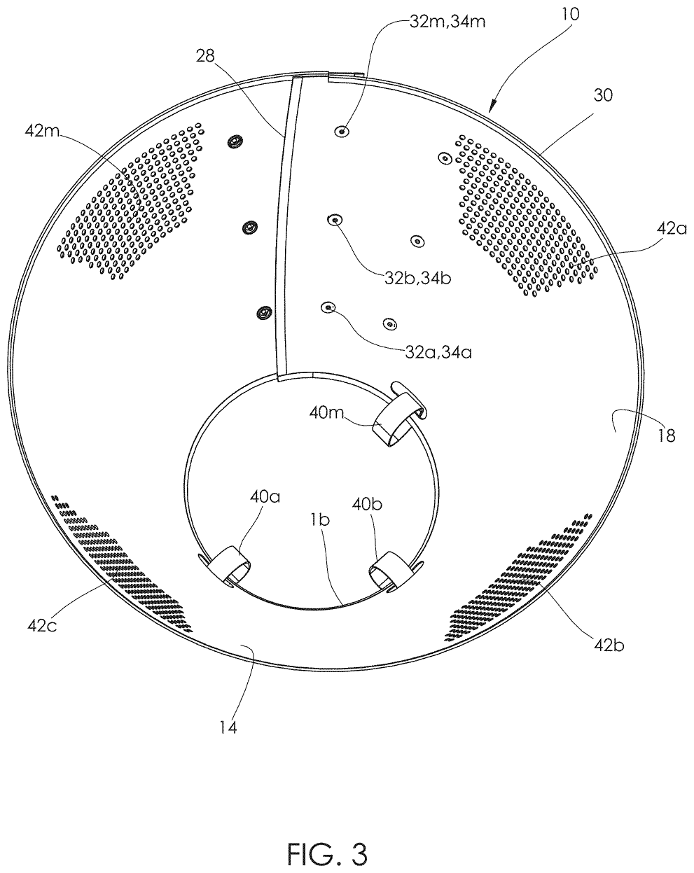

FIG. 1 shows an exemplary recovery cone 10 worn by a dog 12, but of course, another type of animal may wear a recovery cone according to the invention. When worn, the exemplary recovery cone 10 has a main body 14 of a truncated cone shape. The smaller of the two openings of the main body 14 in use is the bottom opening 16 (see FIG. 3), which is positioned around the neck of the dog 12. The top opening 18 has a larger diameter than the bottom opening 16. The top opening 18 preferably is positioned above the head of the dog 12. The top opening 18 is preferably covered with a mesh cover 20.

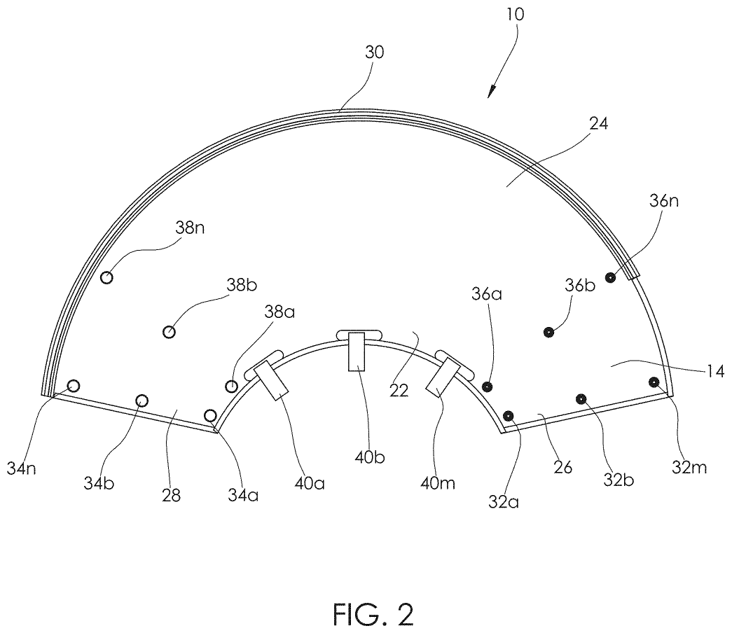

FIG. 2 pictures the exemplary recovery cone 10 in a flat, opened configuration. In this configuration, the main body 14 has four sides including an inner arcuate side 22, an outer arcuate side 24, a first end side 26, and a second end side 28. The inner arcuate side 22 and the outer arcuate side 24 are generally parallel to each other and extend between the first end side 26 and the second end side 28. The outer arcuate side 24 has a greater radius than the inner arcuate side 22.

The main body 14 of the exemplary recovery cone 10 is made of a single sheet of polyethylene terephthalate (PETG), which is a plastic resin of the polyester family. An advantage of using PETG is that it is generally “clearer” or more nearly transparent than other related plastic materials. The near transparency of the PETG main body 14 allows the animal an unrestricted view through it. Other embodiments may be made of one or more other materials such as polypropylene, polycarbonate, or acrylic. Other embodiments also may be made up of more than one sheet or the main bodies of those embodiments may include more than one part unlike exemplary recovery cone 10 which is a single sheet.

The PETG main body 14 in the exemplary embodiment 10 is 0.04 inches thick to provide structure to the main body 14 while retaining some flexibility. Other embodiments having a PETG main body may be as thin as 0.02 inches. These thinner embodiments may allow for the recovery cone to be rolled up for storage when not in use. Yet other embodiments having a PETG main body may be as thick as 0.08 inches. These thicker embodiments may be more appropriate for larger sized animals.

In the exemplary recovery cone 10, the perimeter of the main body 14 is covered with a padding 30. It is made up of two parts on this embodiment 10, but other embodiments may differ. In particular, in this embodiment 10, the padding 30 includes an inner part and an outer part. The inner part is a piece of round, rubber piping encased in fabric. The outer part is a strip of nylon webbing that has been sewn around the piping. Together, the inner piping and the outer webbing form the padding 30 that is disposed around the entire perimeter of the main body 14. Padding in other embodiments may be made of one or more other materials.

Advantageously, the padding 30 provides a finished look to the recovery cone 10. The padding 30 also makes the recovery cone 10 have softer outer and inner edges than the PETG main body 14. The padding 30 may protect the animal wearing it, may reduce damage to walls and furniture by the recovery cone 10, and also may protect a person interacting with an animal wearing the recovery cone 10. As is discussed below in connection with the mesh cover 30, the padding 30 may provide a place of attachment of the mesh cover 30 to exemplary recovery cone 10. Other embodiments may omit all of the padding, may have inner padding along the inner arcuate side 22 and outer padding along the outer arcuate side 24, or may have only inner padding or only outer padding.

To form the truncated cone for an animal's use of the exemplary recovery cone 10, the first end side 26 and the second end side 28 of the main body 14 are connected. In this embodiment 10, snap fasteners are used to connect the sides 26, 28, and particularly, two sets of snap fasteners are provided to allow for at least two different sizes of the cone 10. A first set of snap fasteners are disposed near the respective edges of the sides 26, 28. Specifically, one of the two parts of a snap fastener 32a, 32b, 32n are disposed near the edge of the first end side 26, and the other of the two parts of a snap fastener 34a, 34b, 34n are disposed near the edge of the second end side 28. The two parts 32a, 32b, 32n and 34a, 34b, 34n may be matched up and fastened for a truncated cone of a first size for the recovery cone 10. This first size is the largest size provided by the recovery cone 10 in that it has the widest diameters for its inner opening and outer opening when fastened.

In the exemplary embodiment 10, a second set of snap fasteners are disposed further from the respective edges of the sides 26, 28 than the first set of snap fasteners. Specifically, one of the two parts of a snap fastener 36a, 36b, 36n of the second set of snap fasteners are disposed further from the edge of the first end side 26 than the comparable parts of first set of snap fasteners. The other of the two parts of a snap fastener 38a, 38b, 38n of the second set of snap fasteners are disposed further from the edge of the second end side 28 than comparable parts of the first set of snap fasteners. The two parts 36a, 36b, 36n and 38a, 38b, 38n may be matched up and fastened for a truncated cone of a second size for the recovery cone 10. This second size is the smallest size provided by the recovery cone 10 in that it has the smallest diameters for its inner opening and outer opening when fastened.

The exemplary recovery cone 10 uses a set of three snap fasteners for each size of its truncated cone. Fewer or more snap fasteners may be used. In the exemplary cone 10, the snap fasteners are all of the same size and type, but this may vary in other embodiments. Also, in this embodiment 10, the snap fasteners are made of metal, but snap fasteners of other materials may be used in other embodiments. Two sets of snap fasteners are used in the exemplary recovery cone 10 to provide at least two sizes. Another embodiment may provide only a single set of snap fasteners for only a single size of recovery cone. Other embodiments may provide more than two sets of snap fasteners for more than two sizes of a recovery cone. Yet other embodiments may use a fastener that includes a set of snap fasteners plus additional fastening features. Still other embodiments may provide an alternative fastener.

Another advantage of the exemplary recovery cone 10 is that it may be attached to a collar already worn by an animal. Many animals wear collars for identification, leash attachment, decoration, etc. The exemplary recovery cone 10 provides for an attachment for an animal's collar. Specifically, the exemplary embodiment 10 provides as the attachment three attachment loops 40a, 40b, 40n. They are made of fabric strap material and include a snap fastener with its two parts respectively disposed near opposite ends of the fabric strap material. Each attachment loop 40a, 40b, 40n is attached to or near the interior edge or opening 16 of the recovery cone 10. For example, an attachment loop 40a, 40b, 40n may be threaded through a hole or opening in the main body 14 of the recovery cone 10. To secure an attachment loop 40a, 40b, 40n about a collar of an animal, the fabric strap material is passed around the collar so the two parts of the snap fastener of the attachment loop 40a, 40b, 40n may be snapped together.

The three attachment loops 40a, 40b, 40n are spaced apart uniformly around the interior opening 16 of the recovery cone 10, but other embodiments may vary. Also, other embodiments may include fewer or more attachment loops as an attachment to the collar or may include other ways of attaching a recovery cone to a collar of an animal.

FIG. 3 is a top view of the exemplary recovery cone 10 in a closed configuration as would be worn by an animal. FIG. 3 illustrates another advantageous feature of the exemplary recovery cone 10 according to the invention. The advantageous feature is an air flow feature. Recovery cone 10 is provided with four groups of holes 42a, 42b, 42c, 42n in the main body 14 of the cone 10. In each group of holes 42a, 42b, 42c, 42n, many small holes are included. The holes are small to prevent the animal wearing the recovery cone 10 from pushing a tongue or snout or other body part through a hole. This preventative feature may protect the animal from accessing an area of its body that should be left to heal. Yet, the smallness of the holes is offset to allow for air flow by there being many holes in a group, and there being four groups of holes 42a, 42b, 42c, 42n in the main body. The four groups of holes 42a, 42b, 42c, 42n are distributed evenly about the main body 14 of the exemplary recovery cone 10, but other embodiments may vary. Other embodiments may use bigger holes in a group. Also, other embodiments may use fewer or more groups of holes. Further, other embodiments may not use holes in groups, but distribute the holes around the main body of a recovery cone. Other manners of providing air flow through the recovery cone may be implemented in other embodiments.

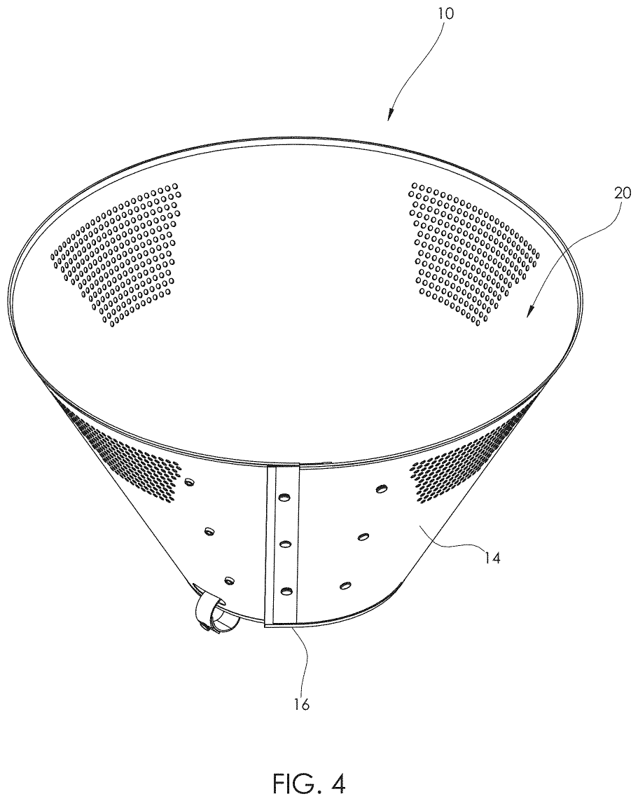

FIG. 4 is a side perspective view of the exemplary recovery cone 10 with the mesh cover 20 in place completely over the top opening of the recovery cone 10. Other embodiments may provide a cover that does not completely cover the top opening of the recovery cone 10. The mesh collar 20 is removable in this embodiment 10 but may be otherwise in other embodiments. Also, in the exemplary embodiment 10, the mesh collar 20 is generally circular and sized to cover the circular top opening of the recovery cone 10.

The mesh cover 20 may be attached to the recovery cone 10 in any appropriate manner. In this embodiment 10, the mesh cover 20 is attached with a Velcro® brand fastener or another hook and loop fastener. One part of the hook and loop fastener is disposed around or near the inside outer edge of the mesh cover 20. The other part of the hook and loop fastener is disposed around or near the outside edge of the top opening of the recovery cone 10. In particular, the other part of the hook and loop fastener is disposed on or near the outside bottom of the padding that encircles the top edge or top opening of the recovery cone 10. Other ways of attaching the mesh cover may be used in other embodiments.

FIGS. 5-7 illustrate a second exemplary protective collar 50 according to the invention as worn by a dog 52. The second embodiment 50 may be said to include three principal parts: (1) the truncated cone 54; (2) the cover of the cone 56; and (3) a neck collar 58 set around the bottom or narrow diameter of the truncated cone 54. The characterization of the cover 56 and the neck collar 58 as principal parts of the second exemplary protective collar 50 may be a misnomer at least because the truncated cone 54 of the second embodiment 50 may be used without one or both of the cover 56 and the neck collar 58.

Generally, the second embodiment 50 compares to the first embodiment 10 with respect to the truncated cone 54 at least with respect to size and shape. In construction, however, the truncated cone 54 of the second embodiment 50 differs from the plastic truncated cone 14 of the first embodiment 10. The truncated cone 54 of the second embodiment 50 is configured to include a neck ring 60 that defines the smaller or less wide circular end of the truncated code 54. The neck ring 60 may be made of any suitable material. For example, the neck ring 60 may be made of metal and/or plastic. The larger or wider circular end 62 of the truncated cone 54 is defined by an outer ring 62 that also may be made of any appropriate material such as metal and/or plastic.

Between the neck ring 60 and the outer ring 62 are generally perpendicularly disposed spokes or ribs 64a-64n that connect the neck ring 60 and the outer ring 62. The ribs 64a-64n may be made of any appropriate material such as metal and/or plastic.

Also between the neck ring 60 and the outer ring 62 is a netting or mesh fabric 66 that may be connected to the ribs 64a-64n and the neck ring 60 and the outer ring 62. The netting 66 may have openings such that the dog or animal wearing the second embodiment 50 may see through the netting 66. The openings of the netting 66 may allow for air flow through the netting 66, which may make the dog 52 (or other animal wearing the second embodiment 50) more comfortable in various ways. For example, the openings of the netting 66 may allow the dog 52 to feel the air flow through the netting 66 and to smell through the netting 66. As another example, the openings of the netting 66 may allow the dog to hear more clearly than with a protective collar that does not include openings such as the openings in the netting 66.

In some implementations of the second embodiment 50 of the invention, the truncated cone 54 may retain its shape and be slipped whole over the dog's head. In another implementation of the second embodiment 50, the truncated cone 54 may be opened or split apart from a closed position along a generally vertical line between the neck ring 60 and the outer ring 62. The truncated cone 54 may be opened using a handle 68 set along the vertical line of the opening. The handle 68 may facilitate the opening of the truncated cone 54 by creating a space along the vertical line of opening that widens the truncated cone 54 overall. The opened truncated cone 54 may be made to fit around the dog's head and then the truncated cone 54 may be returned to a closed position with no split in the truncated cone 54 by using the handle 68 to facilitate the closure.

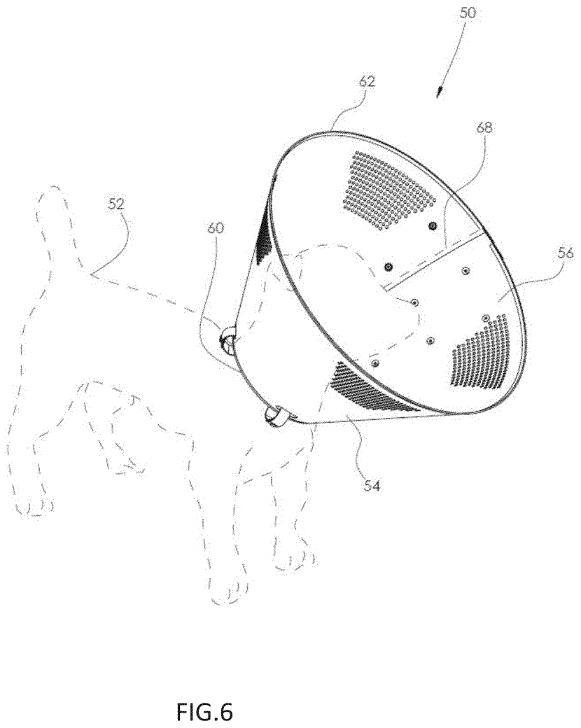

As may be best seen in FIG. 6, the exemplary protective collar 50 may be topped by a cover 56. Advantageously, the cover 56 covers the entire top opening of the protective collar 50 so the animal wearing it is prevented from extending its head or snout past the top of the protective collar 50. Yet, the dog may see, smell and hear through the cover 56 because it is made of a mesh that may compare to the truncated cone of the protective collar 50. The cover 56 may be attached in any appropriate manner to cover the top of the truncated cone of the protective collar 50. The exemplary embodiment 50 uses clips to attach the cover 56 to the truncated cone. Other advantages of the cover 56 compare to the mesh cover 20 discussed above in connection with the exemplary embodiment 10.

As with the exemplary embodiment 10 described above and illustrated in FIGS. 1-4, the exemplary embodiment 50 illustrated in FIGS. 5-7 provides a protective collar 50 whose purposes may include solving one or more of the problems of the prior art as discussed in the background. For example, a purpose of the protective collar 50 may be to keep an animal from injury or choking if the protective collar 50 is pushed further down the animal's neck than intended such as may happen if the animal runs the protective collar 50 into a piece of furniture or other object. To that end, the exemplary protective collar 50 includes a collapsible collar 58 to prevent or at least to minimize the protective collar 50 from pushing down the dog's neck and causing injury or harm to the animal.

The collapsible collar 58 of the exemplary protective collar 50 may be attached to the truncated cone 54 in any appropriate manner such as the clips shown in FIGS. 5-7. The collapsible collar 58 may be made of any appropriate material that allows for a collapsible effect. For example, assume the dog 52 runs into a wall wearing the exemplary protective collar 50. The force of hitting the wall exerts a force on the truncated cone 54 pushing it further down the neck of the dog 52. The truncated cone 54, however, is connected to the collapsible collar 58 so the truncated cone 54 may push against the collapsible collar which may compress or collapse to absorb the force, and then spring back to force the truncated cone 54 to return to its fitted position.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the United States Patent and Trademark Office and the public generally, and especially the scientists, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A protective cone effective as a veterinary restraint when fitted on an animal, the protective cone comprising:
a substantially transparent main body having four sides including an inner arcuate side, an outer arcuate side, a first end side, and a second end side with the inner arcuate side and the outer arcuate side being generally parallel to each other and extending between the first end side and the second end side and with the outer arcuate side having a substantially greater radius than the inner arcuate side,
the main body having at least a fastener to releasably secure the first end side and the second end side into a closed configuration shaped as a truncated cone,
the closed configuration of the main body having an inner opening and an outer opening, the inner opening being substantially smaller than the outer opening with the inner opening being configured to encompass the neck of the animal but not the head, and with the outer opening being configured to encompass at least the head of the animal and to extend beyond the head of the animal;
the main body having perforations to pass air from inside of the closed configuration to outside of the closed configuration,
the main body having an inner padding on the inner arcuate side and having an outer padding on the outer arcuate side;
at least an attachment attached to the inner arcuate side of the main body for attaching the cone to a collar of the animal; and
a substantially circular detachable mesh cover having an outer circumference configured to hold the mesh cover over the outer opening and around the closed configuration of the main body.

2. A protective cone, comprising:
a main body including an inner arcuate side, an outer arcuate side, a first end side, and a second end side with the inner arcuate side and the outer arcuate side extending between the first end side and the second end side and with the outer arcuate side having a substantially greater radius than the inner arcuate side,
the main body having at least a fastener to releasably secure the first end side and the second end side into a closed configuration of a truncated cone shape having an inner opening smaller in diameter than an outer opening; and
a mesh cover covering at least part of the outer opening of the closed configuration of the main body.

3. The protective cone of claim 10, wherein the mesh cover is detachable from the main body.

4. The protective cone of claim 2, wherein the mesh cover is substantially circular having an outer circumference configured to fit over the outer opening and around the closed configuration of the main body.

5. The protective cone of claim 2, further comprising at least an attachment attached to the inner arcuate side of the main body for attaching the closed configuration of the main body to a collar of the animal.

6. The protective cone of claim 2, wherein the main body is substantially transparent.

7. The protective cone of claim 2, wherein the fastener is adjustable to releasably secure the first end side and the second end side into a smaller closed configuration having a smaller inner opening and a smaller outer opening to accommodate an animal having a smaller neck and head size.

8. The protective cone of claim 2, wherein the main body comprises at least a perforation to pass air from outside the closed configuration to inside of the closed configuration.

9. The protective cone of claim 8, wherein the perforation of the main body is included among a group of perforations in the main body.

10. The protective cone of claim 2, wherein the main body comprises two or more groups of perforations.

11. The protective cone of claim 2, wherein the fastener comprises at least a snap fastener.

12. The protective cone of claim 2, wherein the main body comprises an inner padding on the inner arcuate side.

13. The protective cone of claim 2, wherein the main body comprises an outer padding on the outer arcuate side.

14. The protective cone of claim 2, further comprising a compressible collar attached to the inner arcuate side of the main body.

15. The protective cone of claim 14, wherein the compressible collar is detachable from the main body.

16. A collar for positioning around the neck and head of an animal to prevent the animal at least from licking or worrying an area on the body of the animal, the collar comprising:
an inverted truncated cone having an opening with a first diameter that fits around the neck of the animal with the wall of the inverted truncated cone growing in diameter from the first diameter to a second diameter that encircles the head of the animal, and
the wall of the inverted truncated cone being split at least in one location to allow the inverted truncated cone to be fitted around the head and the neck of the animal;
a closure for closing the split wall of the inverted truncated cone in a generally close fit around the head and neck of the animal; and
a mesh for covering the top of the inverted truncated cone.

17. The collar of claim 16, wherein the mesh is detachable from the inverted truncated cone.

18. The collar of claim 16, wherein the inverted truncated cone comprises mesh fabric.

19. The collar of claim 18, wherein the inverted truncated cone comprises at least two ribs disposed between the first diameter and the second diameter.

20. The collar of claim 16, further comprising a compressible neck collar attached to the opening with the first diameter of the inverted truncated cone.
